(19) United States
(12) Patent Application Publication
(10) Pub. No.: US 2006/0014436 A1
(43) Pub. Date: Jan. 19, 2006

(54) Memory card connector

(76) Inventor: Lee-Jen Wu, Taipei (TW)

Correspondence Address: MOLEX INCORPORATED, 2222 WELLINGTON COURT, LISLE, IL, 60532, US

(21) Appl. No.: 11/179,194

(22) Filed: Jul. 12, 2005

(30) Foreign Application Priority Data
Jul. 13, 2004 (TW) 93211028
Jul. 13, 2004 (TW) 93211030

(51) Int. Cl. H01R 24/00

(52) U.S. Cl. 439/630

(57) ABSTRACT

A memory card connector includes an insulating housing defining a first card-insertion space and a second card-insertion space for receiving first and second memory cards, respectively. A stop mechanism is movably mounted on the housing and is engageable by the first memory card when inserted into the first space for movement into the second space to prevent the second memory card from being inserted thereinto. The stop mechanism is engageable by the second memory card when inserted into the second space for movement into the first space to prevent the first memory card from being inserted thereinto.

### FIELD OF THE INVENTION

This invention generally relates to the art of electrical connectors and, particularly, to memory card connector that can receive different types of memory cards inserted into different receiving spaces of the connector.

### BACKGROUND OF THE INVENTION

Memory cards are known in the art and contain intelligence in the form of a memory circuit or other electronic program. A card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The card connector readily accommodates insertion and removal of the card to provide quick access to the data and program on the card. The card connector includes terminals for yieldingly engaging the contact array of the memory card. The memory card, itself, writes or reads via the connector and can transmit between electrical appliances, such as a word processor, personal computer, personal data assistant or the like. The card connector most often is mounted on a printed circuit board.

Memory cards commonly are used because of their data storage capability and portability. Different manufacturers produce different types of cards, including the SM (Smart Media) card, the XD (eXtreme Digital) card, the SD (Secured Digital) card, and the MS (Memory Stick) card. For many years, different card connectors have been designed for receiving the different types of memory cards, with each connector only allowing insertion of a single type of card. Due to space limitations in electronic apparatus, it was impractical or impossible to install different types of connectors for all of the different types of memory cards. Therefore, memory card connectors were designed for accommodating multiple types of cards. The multi-card connectors have a plurality of card-insertion spaces with a plurality of respective openings at the front face of the card connector. Each different type of memory card is supposed to be inserted into only one of the card-receiving spaces whereby the contacts on the memory card engage a specific terminal array on the connector.

Multi-card connectors as described above have proved successful because the electronic apparatus does not have to offer additional space for a plurality of different memory card connectors. Unfortunately, problems have been encountered by attempts to insert a given memory card into a wrong card-insertion space. In addition, two types of memory cards might be inserted simultaneously into two insertion spaces. As a result, the multi-card connector is unable to determine which memory card should be accessed, and the user is confused as to which memory card the data is from. Consequently, the use of multi-card connectors have been unreliable, inconvenient and present a number of problems. The present invention is directed to solving these problems and satisfying a need for a memory card connector that can receive different types of memory cards but only in their proper card-insertion spaces in the card connector.

### SUMMARY OF THE INVENTION

An object, therefore, of the invention is to provide a new and improved memory card connector of the character described.

In the exemplary embodiment of the invention, a memory card connector includes an insulating housing defining a first card-insertion space and a second card-insertion space for receiving first and second memory cards, respectively. A stop means is movably mounted on the housing and are engageable by the first memory card when inserted into the first space for movement into the second space to prevent the second memory card from being inserted thereinto. The stop means is engageable by the second memory card when inserted into the second space for movement into the first space to prevent the first memory card from being inserted thereinto.

According to one preferred embodiment of the invention, the stop means comprises a one-piece stop component movably mounted on the housing and including a first engagement surface engageable by the first memory card when inserted into the first space and a second engagement surface engageable by the second memory card when inserted into the second space. The first and second engagement surfaces are located to perform dual functions of defining first and second stop surfaces abuttable by a respective one of the first and second memory cards when the other memory card is inserted into its respective space. As disclosed herein, the insulating housing is generally flat in a horizontal plane. The one-piece stop component is mounted on the housing for vertical movement relative thereto generally perpendicular to the plane.

According to a second preferred embodiment of the invention, the stop means comprises a two-piece stop assembly including first and second, relatively movable stop elements. The first stop element has a first engagement surface engageable by the first memory card when inserted into the first space. The second stop element has a second engagement surface engageable by the second memory card when inserted into the second space. The first and second stop elements have mutually engageable biasing surfaces, whereby one stop element moves the other stop element into stopping position in response to the one stop element being engaged by its respective memory card. The first stop element has a first stop surface abuttable by the first memory card when the second memory card is inserted into the second space. The second stop element has a second stop surface abuttable by the second memory card when the first memory card is inserted into the first space. Again, the insulating housing is generally flat in a horizontal plane. The first stop element is mounted on the housing for vertical movement relative thereto generally perpendicular to the plane. The second stop element is mounted on the housing for horizontal movement relative thereto generally parallel to the plane.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a memory card connector according to a first embodiment of the invention, with the cover and the stop component lifted off of the base housing;

FIG. 2 is a view somewhat similar to FIG. 1, with the cover reoriented and the stop component mounted in the base housing;

FIG. 3 is a perspective view of the connector in FIGS. 1 and 2, in assembled condition;

FIG. 4 is a perspective view of the base housing of the connector;

FIG. 5 is an enlarged perspective view of the stop component;

FIG. 6 is a perspective view of the stop component, looking at the bottom of the component as viewed in FIG. 5;

FIG. 7 is an enlarged front elevational view of the connector, with a first type of memory card inserted thereinto;

FIG. 7A is a vertical section taken generally along line 7A-7A of FIG. 7;

FIG. 8 is a view similar to that of FIG. 7, with the connector receiving a second type of memory card;

FIG. 8A is a vertical section taken generally along line 8A-8A of FIG. 8;

FIG. 9 is a view similar to that of FIGS. 7 and 8, with the connector receiving a third type of memory card;

FIG. 10 is a view similar to that of FIGS. 7, 8 and 9, with the connector receiving a fourth type of memory card;

FIGS. 11-14 are views similar to that of FIGS. 1-4, but of a second embodiment of the invention;

FIGS. 15 and 16 are enlarged perspective views, taken at different angles, of the two interengageable stop elements of the second embodiment, in disengaged condition;

FIGS. 17 and 18 are views similar to that of FIGS. 15 and 16, respectively, but with the two interengageable stop elements in engagement;

FIG. 19 is a further enlarged elevational view of the two stop elements interengaged;

FIG. 20 is a view similar to that of FIG. 14, but with the two stop elements mounted in the base housing;

FIG. 21 is a front elevational view of the connector according to the second embodiment, receiving a first type of memory card;

FIGS. 22-24 are views similar to that of FIGS. 17-19, but showing the position of the first stop element when engaged by the first type of memory card;

FIG. 25 is a view similar to that of FIG. 20, with the stop elements in positions as engaged by a second type of memory card;

FIG. 26 is a front elevational view of the connector according to the second embodiment, receiving a second type of memory card;

FIG. 27 is a view similar to that of FIG. 26, with the connector receiving a third type of memory card; and

FIG. 28 is a view similar to that of FIGS. 26 and 27, with the connector receiving a fourth type of memory card.

### DETAILED DESCRIPTION OF THE PREFERRED EMBODIMENTS

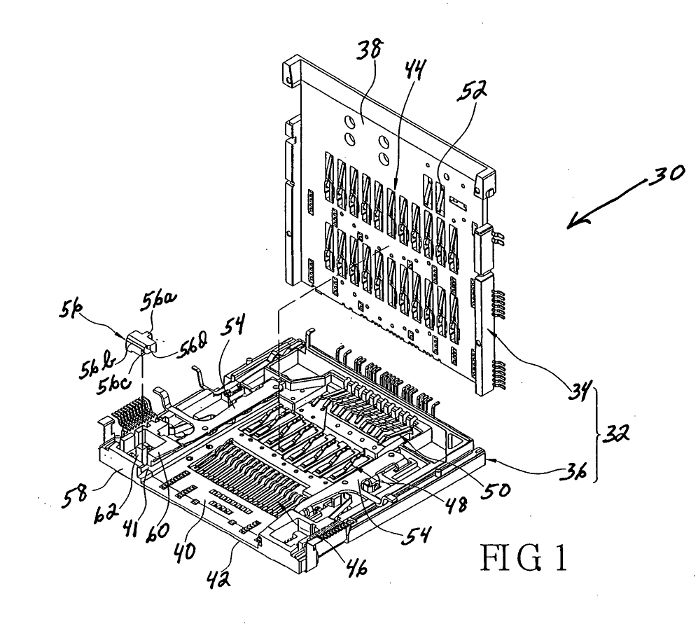

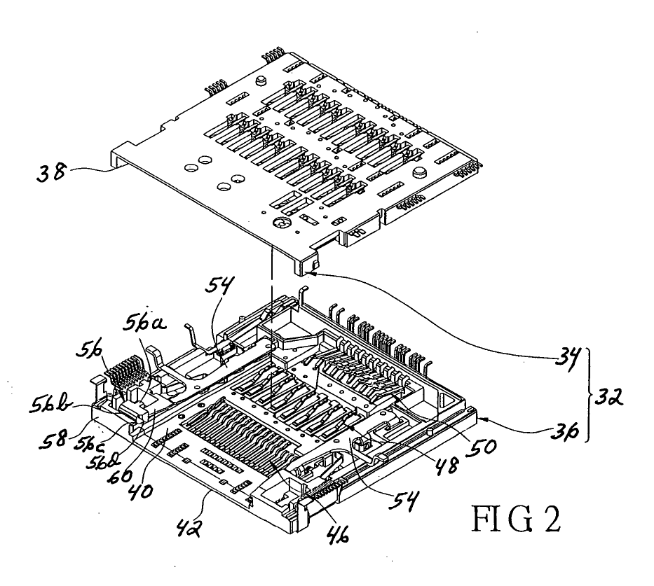

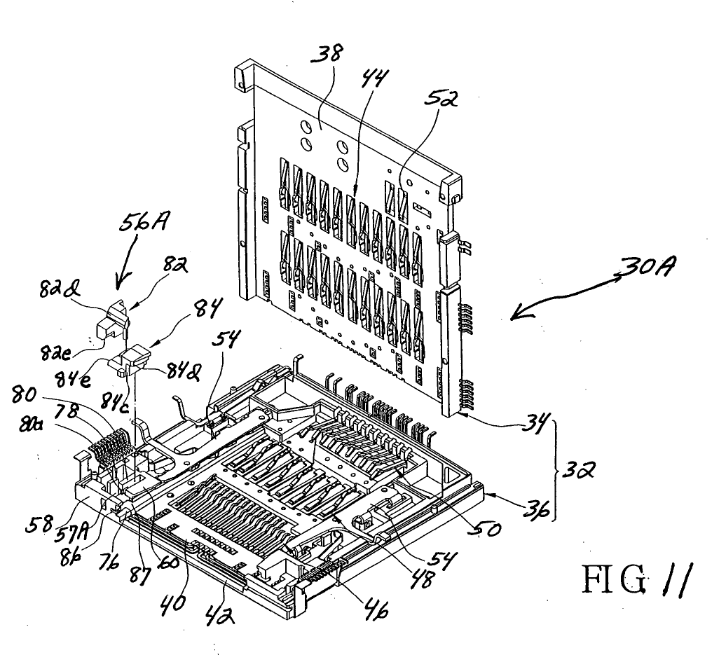

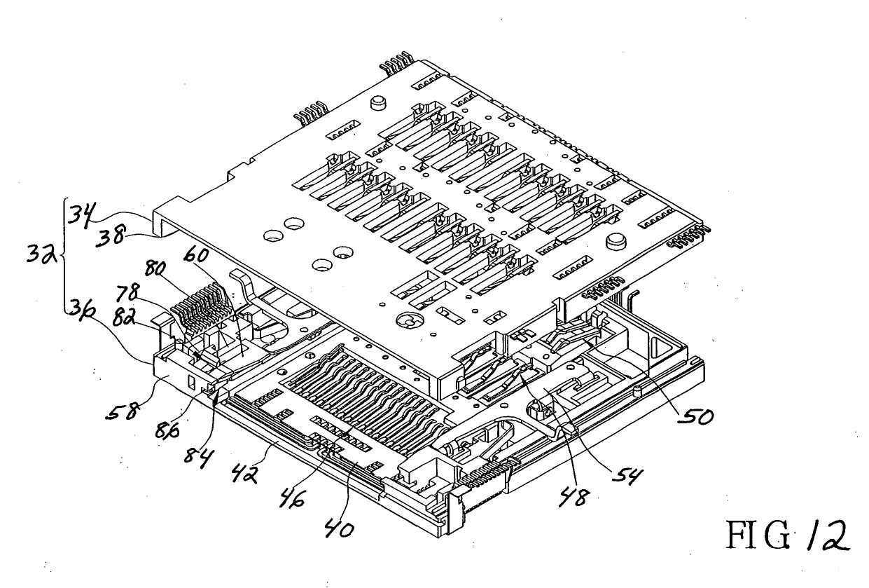

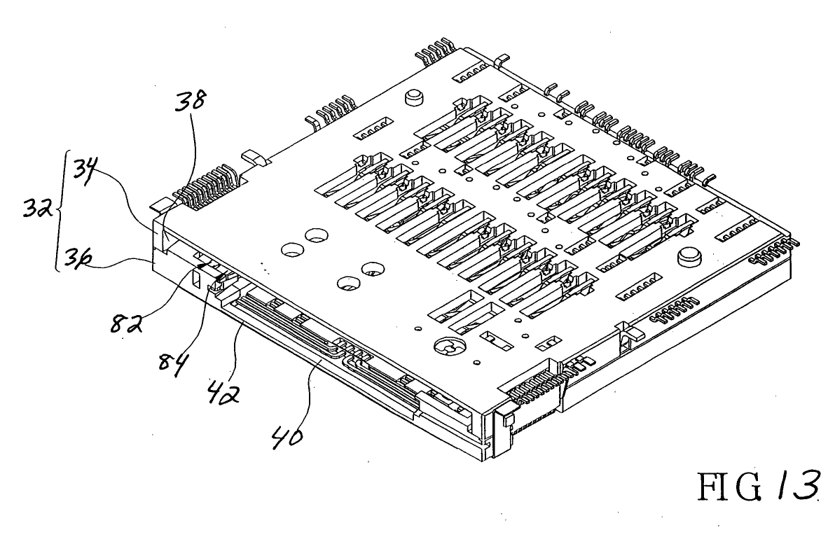

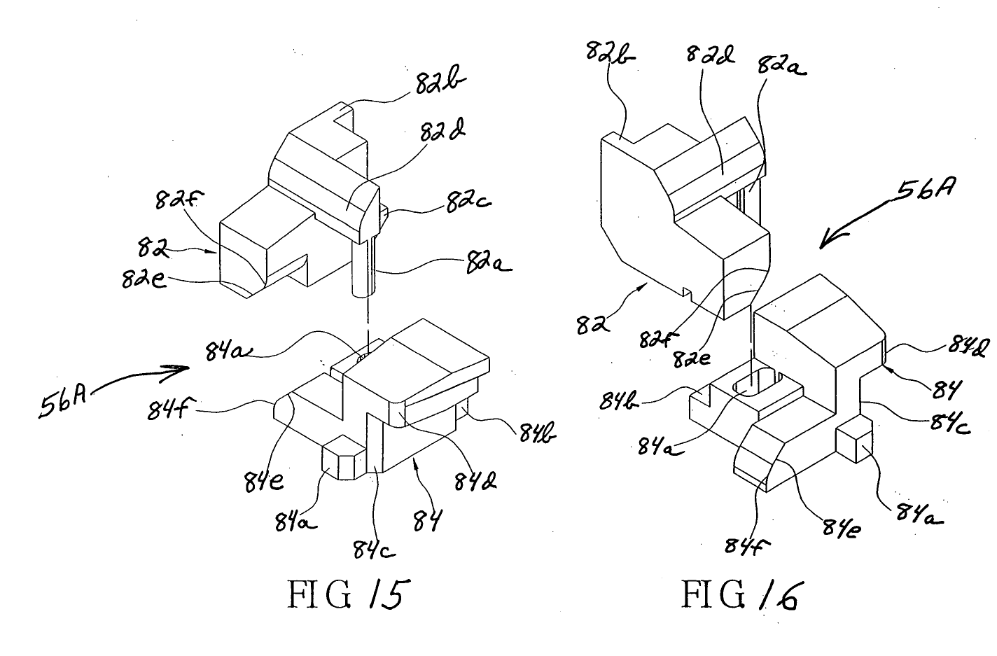

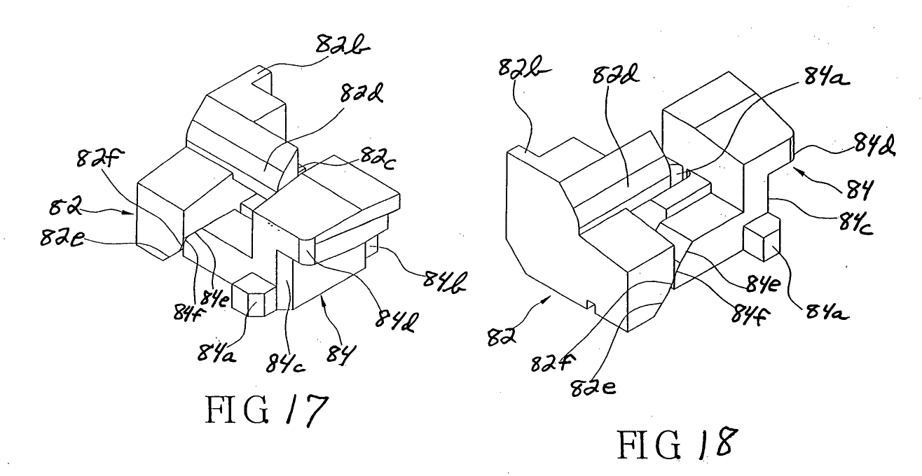

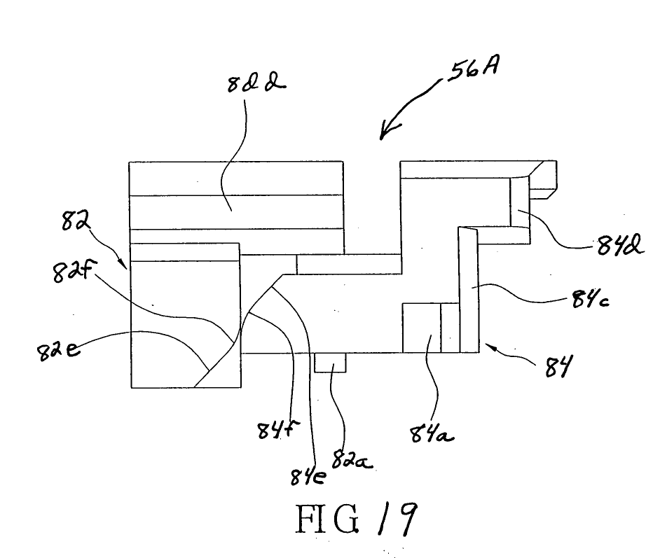

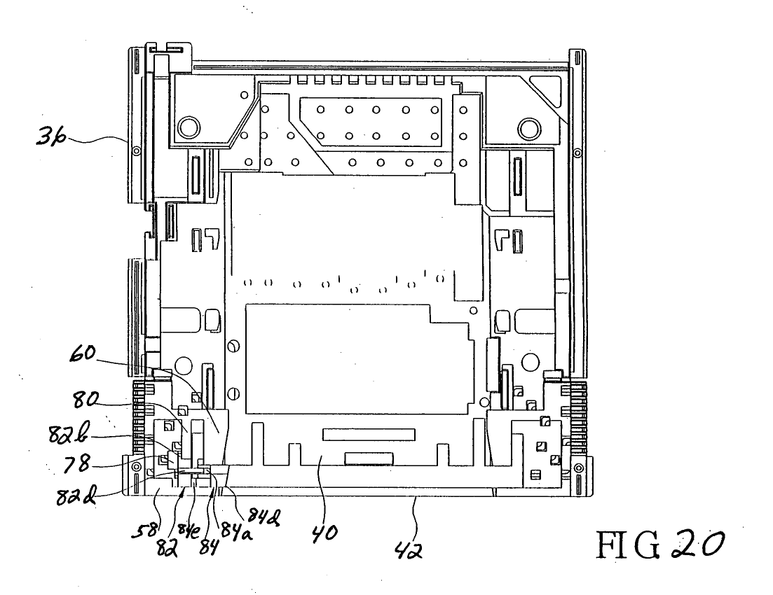

Referring to the drawings in greater detail, a first embodiment of the invention is shown in FIGS. 1-10, and a second embodiment of the invention is shown in FIGS. 11-28. Both embodiments are shown in the drawings for mounting a printed circuit board on the top of the connector(s) to facilitate an illustration of the terminal connections, it being understood that the card connector(s) most likely would be mounted on top of the printed circuit board. The connectors of both embodiments are designed for receiving multiple or different types of memory cards. Generally, both embodiments include stop means for preventing a given memory card from being inserted into a wrong card-insertion space of the connector. With those understandings, such terms as “horizontal”, “vertical”, “upper”, “lower” and the like herein and in the claims hereof are not meant to be limiting in any way. Such terms are used to provide a clear and concise understanding of the invention as viewed in the drawings, it being understood that the connectors of both embodiments are omni-directional in use.

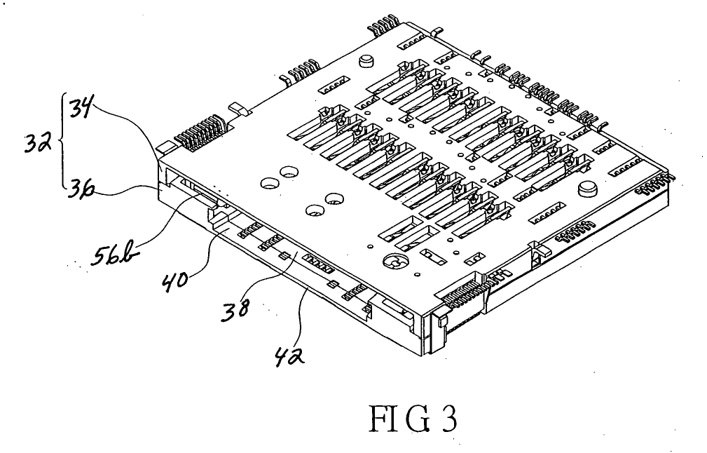

With those understandings, reference is made first to FIGS. 1-3 wherein a first embodiment of a memory card connector is generally designated 30. The connector includes a two-part housing 32 formed by a cover, generally designated 34, and a base housing, generally designated 36. Both the cover and the base housing are fabricated of dielectric material, such as plastic or the like, and are secured in assembled condition as shown in FIG. 3, as by ultrasonic welding, fastening elements or the like. When so assembled, the two-part housing defines a first or upper card-receiving space 38 and a second or lower card-receiving space 40. The spaces combine to form an overall receiving cavity 41 having an insertion opening 42 between the cover and the base housing.

Card connector 30 mounts four sets of conductive terminals for four different types of memory cards. A first set of terminals, generally designated 44, are mounted on cover 34 and have contact portions for engaging the contacts of an SM (Smart Media) type memory card. A second set of terminals, generally designated 46, are mounted on base housing 36 and have contact portions for engaging the contacts of an XD (Extreme Digital) type memory card. A third set of terminals, generally designated 48, are mounted on base housing 36 and have contact portions for engaging the contacts of an SD (Secured Digital) type memory card. A fourth set of terminals, generally designated 50, are mounted on base housing 36 for engaging the contacts of an MS (Memory Stick) type memory card. All of the terminals have tail portions for connection to appropriate circuit traces on the printed circuit board. It should be understood that the numbers and types of terminals may have different designs for accommodating different types of memory cards and are not restricted by the description of the invention herein. In addition, a pair of protection terminals 52 may be mounted on cover 34, and a pair of guide plates 54 may be mounted on base housing 36 for guiding memory cards into cavity 41.

It can be seen from FIGS. 1-3 that the overall memory card connector 30, as well as cover 34 and base housing 36, are generally flat in a horizontal plane. When the connector is mounted on the printed circuit board, the flat plane of the connector is generally parallel to the printed circuit board.

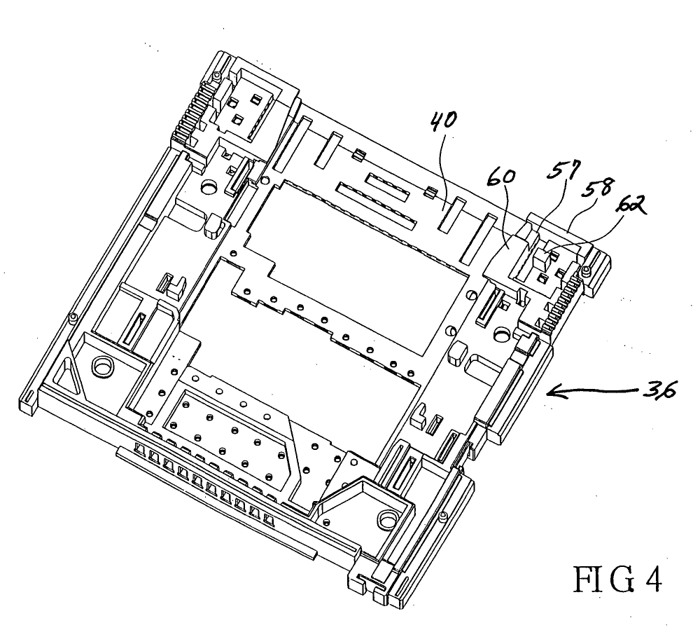

The first embodiment of the invention centers around a single or one-piece stop component, generally designated 56, which is mounted downwardly into base housing 36 at the front left-hand corner thereof as viewed in the drawings. As best seen in FIG. 4, the mounting cavity 57 into which the stop component is mounted, is shown inside a front wall 58 of the base housing and is restricted between an inner wall 60 and a restriction post 62.

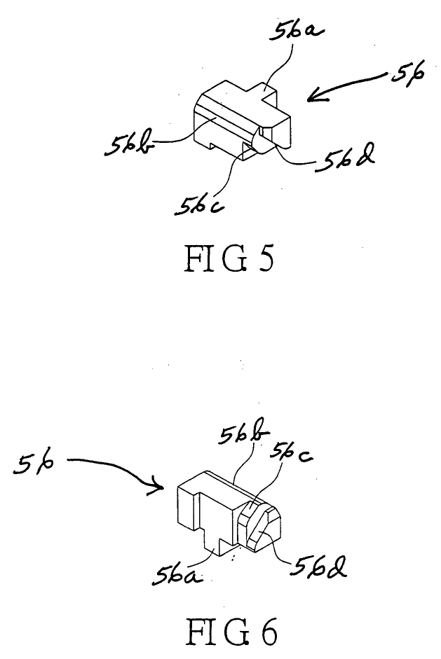

Referring to FIGS. 5 and 6 in conjunction with FIGS. 1, 2 and 4, the one-piece stop component 56 includes a vertically extending positioning rib 56a at the rear of the component. When the stop component is mounted into mounting cavity 57 (FIG. 4) of base housing 36, rib 56a is sandwiched between restriction post 62 and inner wall 60 of the base housing. When so assembled, the stop component is slidably movable relative to the base housing in a vertical direction generally perpendicular to the flat horizontal plane of the base housing and the connector. After the stop component is mounted in the base housing, cover 34 is secured to the base housing as described above.

As best seen in FIGS. 1, 5 and 6, the one-piece stop component 56 includes a first engagement surface 56b, a second engagement surface 56c and a third engagement surface 56d. All three engagement surfaces are at an angle and generally face toward the insertion direction of the memory cards. In other words, the engagement surfaces face insertion opening 42. The first engagement surface 56b is engageable by the first or SM type memory card. The second engagement surface 56c is engageable by the second or XD type memory card. The third engagement surface 56d is engageable by the third or SD type memory card. In general, when one of the memory cards is inserted into its respective insertion space 38 or 40, the engagement of that card with its respective engagement surface 56b-56d will move stop component 56 into the opposite insertion space 38 or 40 and prevent a memory card from being inserted thereinto.

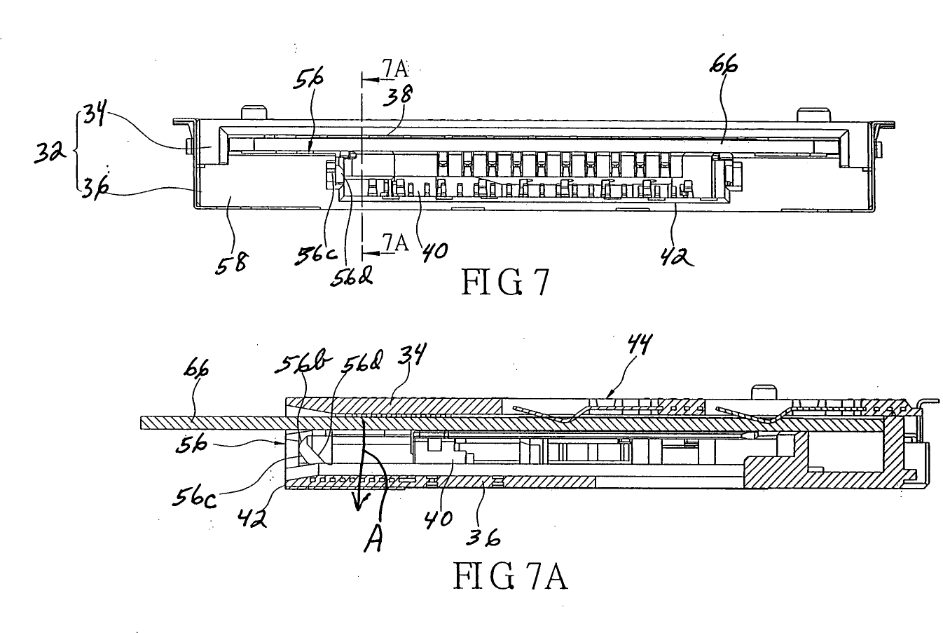

More particularly, FIGS. 7 and 7A show a first or SM type memory card 66 inserted into the upper card-receiving space 38 until the contacts on the card engage the first set of terminals 44 mounted on cover 34. As the SM card is inserted, the leading edge thereof engages the first engagement surface 56b of stop component 56 and slidably moves the stop component downwardly in the direction of arrow “A” into the lower card-receiving space 40 and, in essence, blocks the lower card-receiving space so that no memory card can be inserted thereinto.

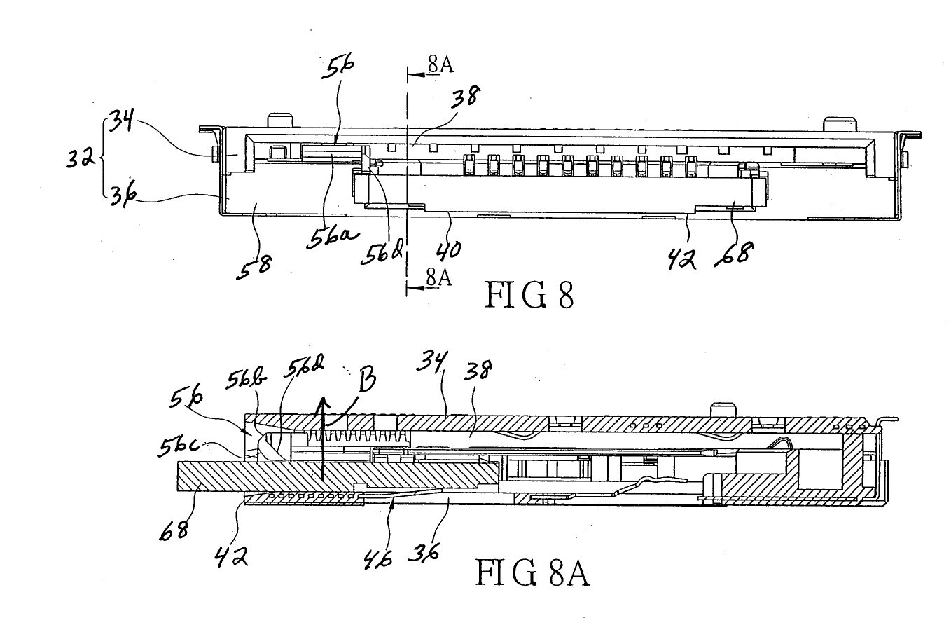

On the other hand, FIGS. 8 and 8A show a second or XD type memory card 68 inserted into the lower card-receiving space 40 whereupon the contacts on the XD card engage the second set of terminals 46. During insertion, the leading edge of the XD card engages the second engagement surface 56c of stop component 56 and biases the stop component upwardly in the direction of arrow “B” (FIG. 8A). With the XD type memory card inserted into the lower card-receiving space 40, stop component 56 now blocks the upper card-receiving space 38 to prevent any memory card from being inserted thereinto.

FIG. 9 shows a third or SD type memory card 70 inserted into the lower card-receiving space 40 for engaging the third set of terminals 48 (FIG. 1). During insertion, the leading edge of the SD type memory card engages the third engagement surface 56d of stop component 56 and, like the XD card 68 in FIGS. 8 and 8A, drives the stop component upwardly into the upper card-receiving space 38 and prevents any memory card from being inserted thereinto.

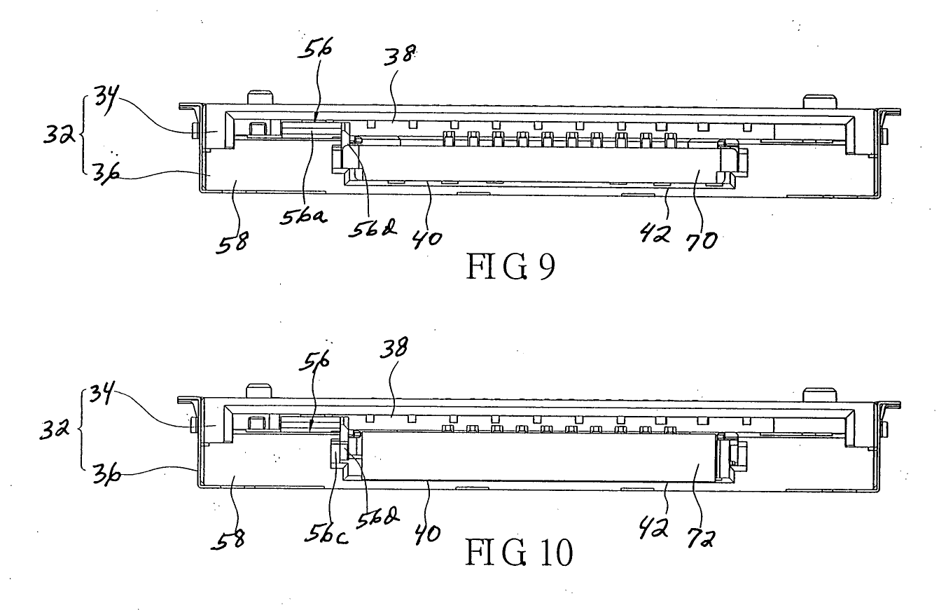

FIG. 10 shows the fourth or MS type memory card 72 inserted into the lower card-receiving space 40. It can be seen that the MS type card is quite thick or high when inserted into the connector and, thereby, restricts the upper card-receiving space 38 that no other type of memory card can be inserted into the upper space.

FIGS. 11-28 show a second embodiment of the invention incorporated in a memory card connector, generally designated 30A. The connector, itself, is very similar to connector 30. The principal differences between the two embodiments reside in the one-piece stop component 56 of the first embodiment (FIGS. 1-10) has been changed to a two-piece stop assembly, generally designated 56A in FIGS. 11-28. Both embodiments of the one-piece stop component 56 and the two-piece stop assembly 56A still provide stop means movably mounted on the connector housing to prevent a memory card of a given type from being inserted into a wrong card-receiving space in the connector.

Therefore, like reference numerals have been applied in FIGS. 11-28 corresponding to like components described above in regard to the first embodiment and shown in FIGS. 1-10. The descriptions of those components will not be repeated. Suffice it to say, the second embodiment of memory card connector 30A includes a two-part housing 32 including a cover 34 and a base housing 36, along with a first set of terminals 44, a second set of terminals 46, a third set of terminals 48 and a fourth set of terminals 50 for engaging the contacts on SM, XD, SD and MS types of memory cards, respectively. Connector 30A includes a first or upper card-receiving space 38 and a second or lower card-receiving space 40.

As best seen in FIG. 14, a first cavity part 74 and a second cavity part 76 are formed in the front left-hand corner of base housing 36 behind front wall 58 and adjacent inner wall 60. A restriction post 78 and a restriction wall 80 project upwardly within the cavity parts.

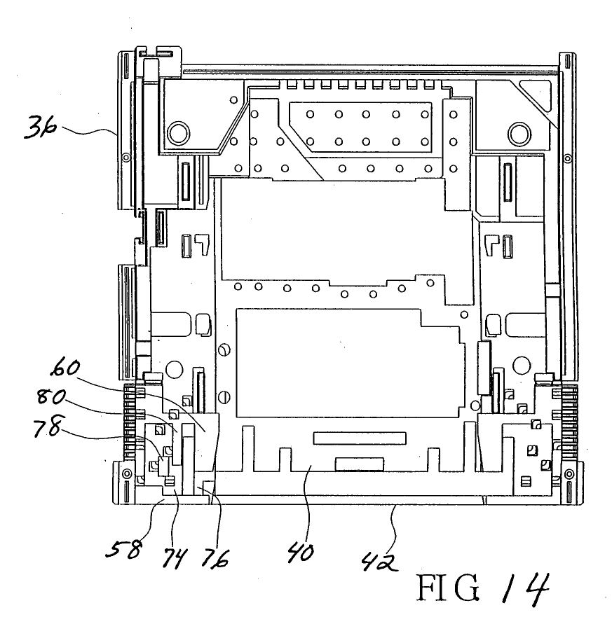

Referring to FIGS. 15-19, stop assembly 56A includes a first stop element, generally designated 82, and a second stop element, generally designated 84. Each stop element is a one-piece structure, which may be molded of plastic material or the like. The first stop element includes a vertically depending guide post 82a which is positioned within a horizontally elongated guide hole 84a of the second stop element whereby the two stop elements are interengaged but are relatively movable in both vertical and horizontal directions.

The first stop element 82 of stop assembly 56A includes a vertically extending positioning rib 82b and a lower block 82c, both at the back side of the stop element. Lower block 82c is slidably disposed in a bottom cutout 80a of restriction wall 80. The first stop element has a first engagement surface 82d which faces forwardly toward insertion opening 42. A biasing surface 82e, having a chamfered surface portion 82f, faces the second stop element 84.

The second stop element 84 has a front positioning block 84a and a rear positioning block 84b. The second stop element has a second engagement surface 84c and a third engagement surface 84d both of which face forwardly toward insertion opening 42. Finally, the second stop element includes a biasing surface 84e, having a chamfered portion 84f, which face the biasing surface 82e and chamfered portion 82f of the first stop element 82 as is best seen in FIG. 19.

When the first and second stop elements 82 and 84, respectively, of stop assembly 56A are mounted within base housing 36, the stop elements are mounted inside the first and second cavity parts 74 and 76, respectively (FIG. 14). Specifically, the first stop element 82 is mounted within the first cavity part 74 by slidably disposing positioning rib 82b between restriction post 78 and restriction wall 80. Positioning boss 82c is disposed in a bottom cutout of restriction wall 80. When so mounted, the first stop element can move relative to base housing 36 and the second stop element 84 in a vertical direction. The second stop element is mounted within the second cavity part 76 for relative horizontal movement due to the elongation of guide hole 84a. Front positioning block 84a of the second stop element is slidably disposed within a front guiding slot 86 of the base housing, while the rear positioning block 84b is slidably disposed within a rear guiding slot 87 of the base housing so that the second stop element can move toward and away from the first stop element in a horizontal direction. In other words, the first stop element 82 relatively moves in a vertical direction due to the vertical elongation of guide post 82a, and the second stop element 84 relatively moves in a horizontal direction due to the elongation of guide hole 84a.

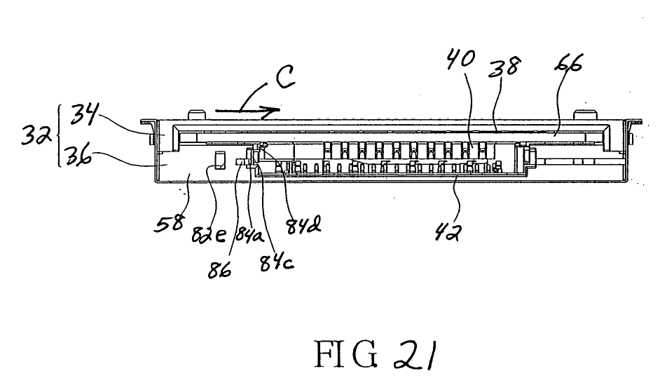

In operation of the second embodiment, FIG. 21 shows a first or SM type memory card 66 inserted into the upper card-receiving space 38 similar to FIG. 7 of the first embodiment. During insertion, the leading edge of the SM card will engage engagement surface 82d of the first stop element 82 and drive the stop element downwardly whereupon biasing surface 82e and chamfered portion 82f of the first stop element engage biasing surface 84e and chamfered portion 84f of the second stop element 84 and pushes the second stop element horizontally into the bottom card-receiving space 40 in the direction of arrow “C”. This prevents any memory card from being inserted into the bottom space as the engagement surface 84c and 84d of the second stop element now form stop surfaces that block the insertion of any memory card into the bottom space.

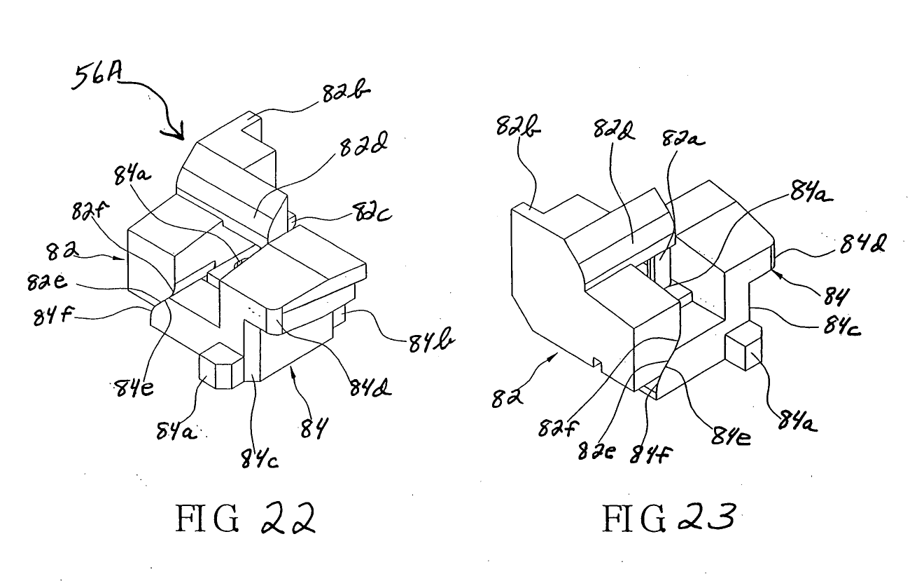

On the other hand, FIG. 26 shows a second or XD type memory card 68 (FIG. 26) (as well as FIGS. 22-25) inserted into the lower card-receiving space 40. During insertion, the leading edge of the XD card engages the second engagement surface 84c of the second stop element 84 and pushes biasing surface 84e and chamfered portion 84f against biasing surface 82e and chamfered portion 82f of the first stop element 82. This biases the first stop element upwardly in the direction of arrow “D” (FIG. 26) into the top card-receiving space 38 to block or stop the insertion of any memory card thereinto.

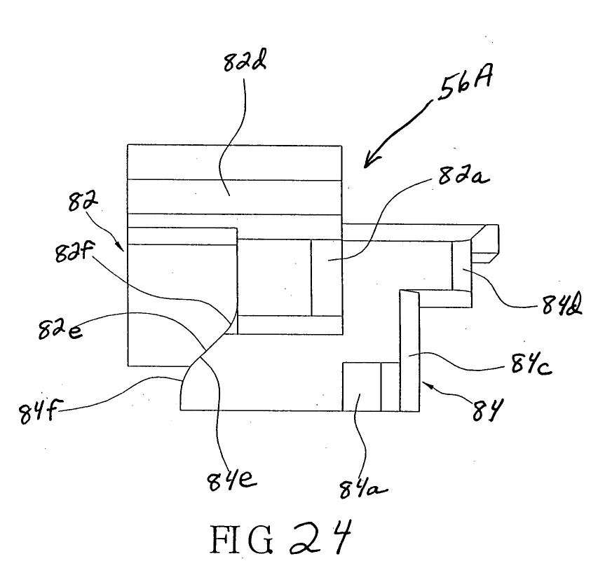

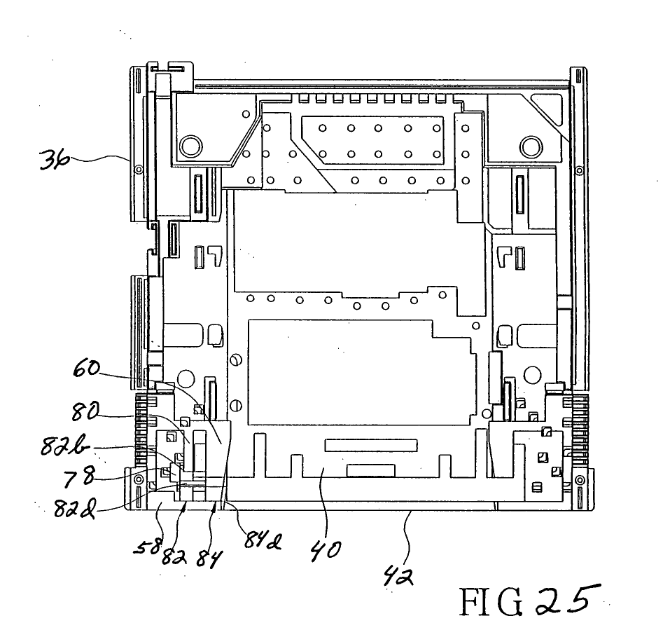

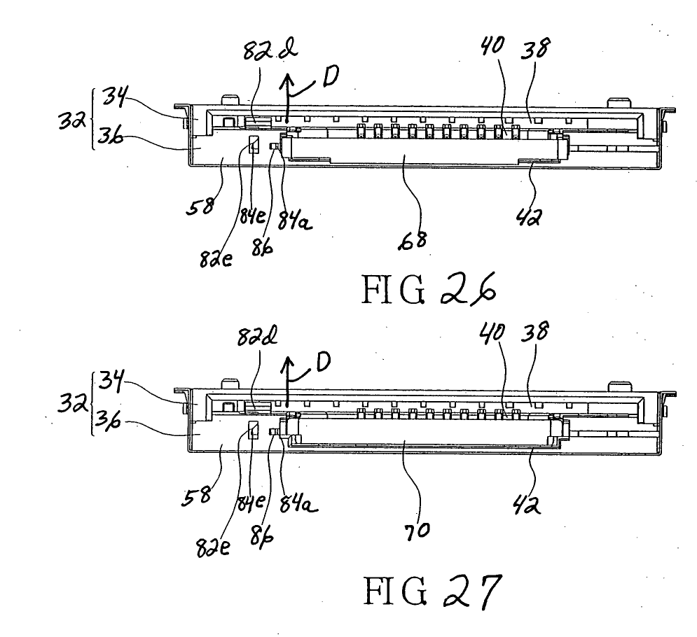

Similarly, and referring to FIG. 27 (as well as FIGS. 22-25), when a third or SD type memory card 70 is inserted into the lower card-receiving space 40, the stop assembly functions quite similarly to the above description of insertion of the XD card. Specifically, the leading edge of the SD card engages the third engagement surface 84d of the second stop element 84 and pushes the stop element horizontally which, in turn, raises the first stop element 82 upwardly in the direction of arrow “D” into blocking condition within the upper space 28. It can be seen in both FIGS. 26 and 27 that the engagement surface 82d of the first stop element performs a dual function of now becoming a stop surface blocking the upper space 38 to prevent any memory card from being inserted thereinto.

In summation, when an SM card 66 is inserted into the upper space 38, the first stop element 82 is pushed downwardly which, in turn, pushes the second stop element 84 inwardly in the direction of arrow “C” (FIG. 21) to block the lower space 40. When an XD or SD type memory card is inserted into the lower space 40, the card pushes the second stop element 84 horizontally outwardly which, in turn, pushes the first stop element 82 vertically upwardly in the direction of arrows “D” (FIGS. 26 and 27) to block insertion of any memory card into the upper space.

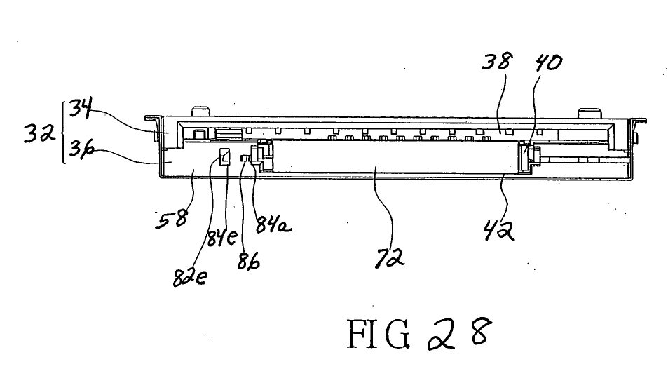

Finally, FIG. 28, like FIG. 10 of the first embodiment, shows a fourth or MS type memory card 72 inserted into the lower card-receiving space 40. Again, the MS card is so thick or high that it projects into upper space 38 and prevents any memory card from being inserted thereinto.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector, comprising:
an insulating housing defining a first card-insertion space and a second card-insertion space for receiving first and second memory cards, respectively; and
stop means movably mounted on the housing and engageable by the first memory card when inserted into the first space for movement into the second space to prevent the second memory card from being inserted thereinto, the stop means being engageable by the second memory card when inserted into the second space for movement into the first space to prevent the first memory card from being inserted thereinto.

2. The memory card connector of claim 1 wherein said stop means comprises a one-piece stop component movably mounted on the housing and including a first engagement surface engageable by the first memory card when inserted into the first space and a second engagement surface engageable by the second memory card when inserted into the second space.

3. The memory card connector of claim 2 wherein said first and second engagement surfaces are located to perform dual functions of defining first and second stop surfaces abuttable by a respective one of the first and second memory cards when the other memory card is inserted into its respective space.

4. The memory card connector of claim 2 wherein said insulating housing is generally flat in a horizontal plane, and said one-piece stop component is mounted on the housing for vertical movement relative thereto generally perpendicular to said plane.

5. The memory card connector of claim 1 wherein said stop means comprise a two-piece stop assembly including first and second, relatively movable stop elements.

6. The memory card connector of claim 5 wherein said first stop element has a first engagement surface engageable by the first memory card when inserted into the first space, and said second stop element has a second engagement surface engageable by the second memory card when inserted into the second space.

7. The memory card connector of claim 6 wherein said first and second stop elements have mutually interengaging biasing surfaces whereby one stop element moves the other stop element into stopping position in response to the one stop element being engaged by a respective memory card.

8. The memory card connector of claim 7 wherein said first stop element has a first stop surface abuttable by the first memory card when the second memory card is inserted into the second space, and said second stop element has a second stop surface abuttable by the second memory card when the first memory card is inserted into the first space.

9. The memory card connector of claim 8 wherein said first and second engagement surfaces on said first and second stop elements, respectively, perform dual functions of defining said first and second stop surfaces, respectively.

10. The memory card connector of claim 5 wherein said insulating housing is generally flat in a horizontal plane, said first stop element being mounted on the housing for vertical movement relative thereto generally perpendicular to said plane, and second stop element being mounted on the housing for horizontal movement relative thereto generally parallel to said plane.

11. A memory card connector, comprising:
an insulating housing defining a first card-insertion space and a second card-insertion space for receiving first and second different types of memory cards, the housing being generally flat in a horizontal plane; and
a one-piece stop component movably mounted on the housing for vertical movement relative thereto generally perpendicular to said plane, the stop component including a first engagement surface engageable by the first memory card when inserted into the first space and a second engagement surface engageable by the second memory card when inserted into the second space, engagement of the first surface by the first memory card effectively moving the stop component into the second space to prevent the second memory card from being inserted thereinto, and engagement of the second surface by the second memory card effectively moving the stop component into the first space to prevent the first memory card from being inserted thereinto.

12. The memory card connector of claim 11 wherein said first and second engagement surfaces are located to perform dual functions of defining first and second stop surfaces abuttable by a respective one of the first and second memory cards when the other memory card is inserted into a respective space.

13. A memory card connector, comprising:
an insulating housing defining a first card-insertion space and a second card-insertion space for receiving first and second different types of memory cards, the housing being generally flat in a horizontal plane; and
a two-piece stop assembly including first and second relatively movable stop elements, the first stop element being mounted on the housing for vertical movement relative thereto generally perpendicular to said plane and including a first engagement surface engageable by the first memory card when inserted into the first space, the second stop element being mounted on the housing for horizontal movement relative thereto generally parallel to said plane and including a second engagement surface engageable by the second memory card when inserted into the second space, the first and second stop elements having mutually interengaging biasing surfaces whereby the first stop element moves the second stop element into stopping position in the second space in response to the first memory card engaging the first stop element, and the second stop element moves the first stop element into stopping position in the first space in response to the second stop element being engaged by the second memory card.

14. The memory card connector of claim 13 wherein said first stop element has a first stop surface abuttable by the first memory card when the second memory card is inserted into the second space, and said second stop element has a second stop surface abuttable by the second memory card when the first memory card is inserted into the first space.

15. The memory card connector of claim 14 wherein said first and second engagement surfaces on said first and second stop elements, respectively, perform dual functions of defining said first and second stop surfaces, respectively.
